(19) United States
(12) Patent Application Publication
(10) Pub. No.: US 2026/0178992 A1
(43) Pub. Date: Jun. 25, 2026

(54) MOBILITY VEHICLE RESERVATION SYSTEM AND METHOD

(71) Applicant: Shady Omar Ayoub, Santa Clarita, CA (US)

(72) Inventor: Shady Omar Ayoub, Santa Clarita, CA (US)

(21) Appl. No.: 19/366,907

(22) Filed: Oct. 23, 2025

Related U.S. Application Data
(60) Provisional application No. 63/737,046, filed on Dec. 20, 2024.

(51) Int. Cl. G06Q 10/02; G06Q 20/10; G06Q 50/40; H04W 4/029

(52) U.S. Cl. CPC G06Q 10/02; G06Q 20/102; G06Q 50/40; H04W 4/029

(57) ABSTRACT

A system for providing a mobility service includes a plurality of mobility vehicles for transporting objects or people. The plurality of mobility vehicles are in communication with a hub for controlling and monitoring activity of the plurality of mobility vehicles. The system includes a plurality of docking station for docking the any of the plurality of mobility vehicles and a mobile device running a mobile application for accessing the system and providing data to and obtaining data from the plurality of docking stations. The mobile application provides reservation and rental workflows for rental of the mobility vehicles. The mobile application provides real time maps of available mobility vehicles and provides confirmation and data points for the rental of the mobility vehicles. The mobile application confirms ending of the process with photo confirmation.

### CROSS-REFERENCE TO RELATED APPLICATIONS

The present application claims the benefit of U.S. Application 63/737,046 filed on 2024 Dec. 20, the content of which is incorporated herein by reference.

### COPYRIGHT AND TRADEMARKS STATEMENT

portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### FIELD OF THE INVENTION

The invention relates to the field of managing reservations of equipment.

### BACKGROUND

Individuals and families frequently encounter barriers to public outings at locations with soft and/or uneven terrain, such as beaches where loose sand presents a difficult surface to traverse. This is a particular for those with disabilities or mobility challenges, who may have difficulty traversing terrain that is not firm and reasonably level.

Beach outings can present significant challenges for individuals and families, especially those with mobility impairments or young children. Families often struggle with transporting bulky items like coolers, chairs, and umbrellas while also managing the needs of small children or strollers. Families typically travel to beaches using a vehicle with limited capacity which is quickly taken up by the bulky items and passengers.

For individuals with disabilities, such as those who use wheelchairs or walkers, the soft, uneven terrain of beaches presents an additional barrier, making access nearly impossible without specialized equipment. According to a study by the CDC, 14% of adults in the U.S. report having mobility disabilities, which complicates vacation planning and may even prevent access to popular destinations like the beach. The lack of accessible pathways and functional tools further compounds these issues, creating a significant physical and emotional burden for those who wish to enjoy beach outings. The inability to visit the beach or enjoy recreational activities due to these barriers leads to a reduced quality of life. Surveys reveal that 68% of individuals with disabilities or mobility challenges are unable to visit the beach as often as they would like, with nearly 45% reporting that they cannot visit the beach at all. For families, the strain of carrying heavy or numerous items over soft sand often discourages beach trips, leading to fewer opportunities for bonding, relaxation, and connection with nature. Many families and individuals with disabilities find themselves excluded from enjoying the full benefits of the beach experience—whether it be social interaction, physical exercise, or the mental health benefits that come from spending time in nature. The lack of inclusive solutions to these problems exacerbates feelings of isolation, particularly for those who already face limitations in other aspects of their daily lives.

Without practical, accessible solutions, the beach—a symbol of leisure and enjoyment —becomes a source of frustration rather than relaxation. These obstacles, both physical and logistical, create a significant deterrent for many, pushing them to avoid the beach altogether. However, recent developments in adaptive technologies, such as mobility mats and motorized beach wheelchairs, have shown promise in improving beach accessibility for people with disabilities and families with young children. The introduction of these tools highlights the importance of innovation in addressing barriers to public spaces, ensuring that everyone, regardless of ability or age, can access and enjoy the benefits of outdoor recreational spaces.

Currently, the process of accessing the beach for many individuals—especially those with disabilities, elderly visitors, and families with young children—can be a significant logistical challenge. For families, the typical beach outing involves packing a variety of items, such as chairs, coolers, umbrellas, towels, and toys, which can be bulky and heavy to transport. These items are often carried by hand or loaded into strollers, making the journey to the beach difficult, particularly when dealing with long stretches of sand. For people with mobility impairments, this challenge is magnified. Individuals who use wheelchairs or walkers often find themselves unable to traverse the soft, uneven sand without assistance, as traditional mobility aids are not suited for such terrain.

Today, people who face mobility issues or have equipment to transport typically rely on traditional methods to get to the beach, including asking for assistance from friends or family or utilizing existing beach services, when available. For families, the journey often begins with packing everything into cars, driving to the beach, and then making the trek across the sand to find a spot. While some locations provide basic accessibility features like ramps or parking spots close to the beach, many still lack comprehensive systems to support those with limited mobility.

These challenges highlight the need for a more accessible and flexible systems to ensure that everyone, regardless of physical ability or age, can enjoy the beach without unnecessary barriers. Similar issues are found at other locations with soft and/or uneven terrain.

### SUMMARY

In general, the present disclosure describes systems and methods for allowing reservations of mobility vehicles (such as beach carts and beach-adapted wheelchairs) that are stored at a location near a beach or other outdoor recreation site with soft and/or uneven terrain, allowing access to such mobility vehicles without requiring visitors to bring them. This facilitates access, as mobility vehicles are typically extremely bulky, and thus would compete for space in a road vehicle with other supplies and passengers transported to the location.

According to one aspect of the present disclosure, a system for providing mobility vehicle access may include a control hub, a plurality of mobility vehicles each having a unique identifier, and one or more docking stations that can each store at least a portion of the plurality of mobility vehicles when not in use. The control hub is in signal communication with the mobility vehicles and/or with the docking station(s), and acts to perform several functions. To place a reservation, the control hub accesses vehicle availability data to present such data to users and allow users to input reservation requests for available mobility vehicles, receives reservation requests and processes payments for reservations, matches reservation information to an available one of the mobility vehicles and updates the vehicle availability data to account for unavailability of the reserved mobility vehicle during the reservation time. To allow a user access to a reserved mobility vehicle, the control hub receives user identification information at the docking station(s) where reserved mobility vehicles are stored and matches users to reservations, and responsive to matching each user with a reservation, allows such user to temporarily access a reserved mobility vehicle, matching the identifier for the accessed mobility vehicle to the reservation.

Systems such as described above may include one or more of the following features. Where the system comprises a plurality of docking stations at different locations, the vehicle availability data may include the location(s) at which mobility vehicles are available, and the control hub can present the vehicle availability data to users in a format including a map identifying locations of available vehicles. The control hub can then allow users to input reservation requests for available mobility vehicles where the reservation request specifies a mobility vehicle location. Where the mobility vehicles of the system include mobility vehicles powered by electric motors, at least some of the docking station(s) can include the capability to recharge batteries in the mobility vehicles to power the electric motors. The control hub may prompt users to input image information to terminate the reservation and store such image information as part of a record of the reservation. The control hub may interact with user devices via a global communications network when performing some of its functions. The control hub may allow users to schedule reservations in advance. Where the control hub is in signal communication with the docking station(s), the mobility vehicles may communicate with the control hub partially or entirely via the docking station(s). Where the mobility vehicles can be enabled and disabled remotely, the system could operate with the access to the mobility vehicles controlled directly from the control hub communicating with each of the mobility vehicles. In such cases, one or more docking stations could be used only for maintenance (such as to recharge mobility vehicle batteries) or could even be omitted from the system.

According to another aspect of the present disclosure, a method of controlling access to a plurality of mobility vehicles, each having a unique identifier, may comprise the steps of accessing vehicle availability data and presenting a user with information on available mobility vehicles, allowing a user to define a reservation for an available mobility vehicle, processing payment information, making a record of the reservation and adjusting the vehicle availability data to account for unavailability of the reserved mobility vehicle during the reservation time, matching the identifier for a particular mobility vehicle to the reservation, receiving user identification information to match the user with the reservation at the location of the particular mobility vehicle(s) identified, and, responsive to matching the received user identification information with the reservation record, allowing the user temporary access to one of the mobility vehicles suitable to match the reservation.

Methods such as described above may have one or more of the following features. Where the mobility vehicles are stored at different locations, the vehicle availability data may include the location(s) at which mobility vehicles are available, and the step of presenting a user with information on available mobility vehicles may include presenting the user with a map identifying locations of available mobility vehicles. In such cases, the step of allowing a user to define a reservation can define a location of the reserved mobility vehicle and the step of making a record of the reservation and adjusting the vehicle availability data can take into account the location of the reserved mobility vehicle. The method may include the step of collecting reservation aggregated reservation data and reporting such aggregated reservation data to a management information database. The method may include the steps of prompting users to input image information to terminate the reservation and storing inputted image information as part of a record of the reservation. The steps of presenting a user with information on available mobility vehicles, allowing a user to define a reservation for an available mobility vehicle, processing payment information, and receiving user identification information may be partially or entirely performed via a user device. The steps of presenting a user with information on available mobility vehicles and allowing a user to define a reservation may allow users to schedule reservations in advance. The method may include the step of tracking the current location of at least currently-accessed vehicles via GPS location capability.

According to another aspect of the present disclosure, a software application for managing access to at least one mobility vehicle may include a reservation manager, a transaction manager, and an access manager. The reservation manager may access vehicle availability data to present a user with information on available mobility vehicles and allow the user to select a reservation for at least one available mobility vehicle. The transaction manager may receive payment information input by the user and, upon confirming the validity of the payment information, process a payment identified by the payment information, record the reservation in a reservation database, and adjust the vehicle availability data to account for unavailability of the reserved mobility vehicle during the reservation time. The access manager may receive user identification information to match the user with a reservation recorded for that user and, responsive to matching the received user identification information with the reservation record, may allow the user temporary access to a mobility vehicle suitable to match the reservation. The access manager may match the reservation with the identifier for the mobility vehicle made accessible to the user.

Software applications such as described above may include one or more of the following features. Where the vehicle availability data includes information on the availability of mobility vehicles at different locations, the reservation manager may present a user with a map of locations where mobility vehicles are available and match reservations to a location selected by the user. Where at least some of the mobility vehicles are powered by electric motors, the access manager may send commands to enable and disable the electric motors to control access. The access manager may prompt users to input image information to terminate the reservation and the transaction manager can store such image information as part of a record of the reservation. The reservation manager may allow users to schedule reservations in advance. The software application may include an administration module that collects aggregated reservation data for each reservation record.

Where various optional features are described, such features should be considered as suitable for combination together in any variation unless such combination is inherently excluded.

These and other objects, features, and advantages of the present invention will become more readily apparent from the attached drawings and the detailed description of the embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIGS. 1A-1E show examples of app screen windows that are part of a rental workflow employed in one example of a method for renting a mobility vehicle;

FIGS. 2A-2C show examples of app screen windows that are part of a reservation workflow employed in one example of a method for reserving a mobility vehicle;

FIG. 3 shows an app screen of a real time map of available mobility vehicles employed in one example of a method for reserving mobility vehicles;

FIG. 4 shows an app screen with a confirmation with various data points and a time employed in one example of a method for reserving mobility vehicles;

FIG. 5 shows an app screen ending the process with photo confirmation employed in one example of a method for reserving mobility vehicles;

FIG. 6 shows one example of a docking station and rental mobility vehicles;

FIG. 7 is a schematic diagram showing one example of a control unit for operating a mobility vehicle;

FIG. 8 is a schematic view showing one example of a system for providing mobility vehicle access where a control hub communicates with a plurality of mobility vehicles via a plurality of docking stations.

FIG. 9 is a schematic view showing one example of a system where a plurality of mobility vehicles communicate directly with a control hub. A plurality of docking stations also communicate with the control hub.

FIG. 10 is a schematic view showing another example of a system where a plurality of mobility vehicles communicate directly with a control hub, but where no docking stations are employed in controlling access to the mobility vehicles.

FIG. 11A is a flow chart showing one example of a method for renting a mobility vehicle at a location;

FIG. 11B is a flow chart showing one example of a method for reserving a mobility vehicle in advance of the time of use and accessing the mobility vehicle at the reserved time;

FIG. 12 is a block diagram illustrating one example of a software application managing access to at least one mobility vehicle.

Corresponding reference characters indicate corresponding parts throughout the several views. The examples set out herein illustrate embodiments of the invention and such examples are not to be construed as limiting the scope of the invention in any manner.

### DETAILED DESCRIPTION

While various aspects and features of certain embodiments have been summarized above, the following detailed description illustrates a few examples of embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

“Mobility vehicle”, as used herein, refers to vehicles adapted for use on soft and/or uneven terrain, and includes vehicles intended for transport of cargo, such as carts or wagons adapted for use on soft terrain (typically by providing enlarged wheels and/or multiple wheels, or wide treads), as well as vehicles intended for transport of passengers, such as wheelchairs adapted for use on soft terrain (typically by providing enlarged wheels and/or multiple wheels, or wide treads). Such mobility vehicles may be unmotorized or motorized. In some cases, mobility vehicles may make use of other adaptations for traversing soft terrain, such as a transport robot or exoskeleton with articulated legs that employs oversized feet. Where one type of mobility vehicle is discussed for purposes of illustration, the substitution of other mobility vehicle types should be understood.

As this invention is susceptible to embodiments of many different forms, it is intended that the present disclosure be considered as an example of the principles of the invention and not intended to limit the invention to the specific embodiments shown and described. For purposes of discussion, much of the discussion is made in terms of providing greater access to beaches; this discussion should be understood as also applying to other outdoor locations where soft and/or uneven terrain may be encountered. In some cases, features may be described in terms of a system, a method, and or a software application; where less than all of these options are mentioned when discussing a feature, it should be understood that such feature may be applicable to other forms of embodiments.

In some embodiments, the systems and/or methods disclosed can provide an innovative mobility aid that combines ergonomic design with technology, enabling users to efficiently transport their belongings. The solution to beach accessibility challenges may integrate mobile applications that allow users to rent mobility aids and equipment directly on-site and on demand, eliminating the need to bring personal gear. This service model allows families, individuals with disabilities, and anyone facing logistical hurdles can access essential tools such as motorized beach wheelchairs, transport carts, and optionally mobility mats without the hassle of transporting them. Mobile apps can streamline this process by providing real-time availability and reservations for equipment at various beach locations, ensuring users have immediate access to the resources they need. By combining technology with adaptive equipment, beachgoers can enjoy the benefits of coastal environments without being burdened by the logistical challenges typically associated with beach outings.

The system is an efficient way to enjoy the beach experience for those seeking to enjoy the sand without the logistical burdens. By leveraging cutting-edge mobile application technology, users can seamlessly access motorized mobility vehicles at various locations through GPS-enabled tracking. Upon arrival, users can download the app, sign in, and view the currently-available mobility vehicles in their vicinity, providing real-time information on which mobility vehicles are ready for use. The application is designed to be intuitive, displaying only available mobility vehicles while automatically filtering out those that are currently rented or reserved.

Once a user selects their preferred mobility vehicle, they can be prompted to scan a unique QR code or manually input the identification number of the mobility vehicle. This can ensure precise tracking and security, linking the user to the specific mobility vehicles they are about to rent. After selecting the mobility vehicle, users may be presented with vital information about the mobility vehicles, such as its location, custodian, and operational details, including the temperature and closing time of the mobility vehicle's availability. Users can also opt for additional protection plans, covering potential incidental damage. Following a brief consent to a rental agreement, users can proceed to payment via standard credit card or integrated mobile payment systems such as Apple Pay® or Google Pay® applications.

Upon successful payment, the mobile app may send an electronic message to an IoT (Internet of Things) system associated with the mobility vehicle, allowing the user access (in the case of a motorized mobility vehicle, this may include allowing activation of the motor). At this point, the user may receives confirmation of their rental, along with a timer that tracks their rental duration, to provide transparency throughout the process. This functionality allows users to enjoy their time on the beach without the burden of manually tracking their rental period. The rental can be terminated at any time, but in some cases certain conditions must be met to ensure proper return and accountability. For example, the user may be required to return the mobility vehicle to within a configurable radius of its original location and/or to capture a photo of both the front and back of the mobility vehicle to verify its condition and location. Once these conditions are satisfied, the app sends a final command to the IoT system to disable the mobility vehicle, officially ending the rental. The user then receives a receipt, and the option to leave a review for the service may be provided to help ensure continuous improvement.

The system and/or method may include administrative tools to provide data for analysis by businesses and organizations that purchase or lease these motorized mobility vehicles, such as hotels, resorts, and other tourism-related establishments. A comprehensive suite of management tools may be provided, and may allow collecting data on reservations and rentals to better manage inventory, provide usage statistics for analysis, and/or to set dynamic pricing options based on demand, mobility vehicle types, and peak periods. For example, higher rates could be implemented during holidays or special events, aiding the service in remaining profitable and efficient. Administrators may also be able to manage the mobility vehicles remotely, including disabling the configurable radius logic, terminating a rental if necessary, and/or enabling and disabling mobility vehicles on demand. Mobility vehicles may be automatically disabled under other circumstances, such as if the user attempts to remove them from within a specified approved region of operation. The integration of autonomous dispatch and recall features, along with a camera system for remote monitoring, may allow the mobility vehicles to be seamlessly deployed, tracked, and returned. Furthermore, one or more secure docking stations can be employed to house, charge, and secure each motorized mobility vehicle, preventing theft and ensuring that the mobility vehicles are always ready for use.

Such integrated solutions as described herein can provide an all-encompassing, user-friendly experience that combines the convenience of technology with the necessity of practical equipment for accessible beach outings. The access to mobility vehicles at the location(s) where they are to be used improves beach accessibility for families, seniors, and individuals with mobility challenges, offering an easy and enjoyable way to enjoy the beach without the burden of transporting heavy equipment.

The reservation workflow of the mobile application technology may also be designed to accommodate users who wish to place a hold on a motorized mobility vehicle ahead of time, offering flexibility for those who want to ensure availability before arriving at the beach. When a user decides to reserve a mobility vehicle in advance, they can select a specific time frame, with hold options currently set at 30 or 60 minutes, though administrators may have the ability to configure these time intervals to better suit demand and operational needs. Once a user selects their preferred hold time, the app confirms the reservation and temporarily locks the selected mobility vehicle for the user for a hold period corresponding to the reservation time, as well as any additional time needed to prepare the mobility vehicle for the next user (such as time for recharging, cleaning, maintenance based on usage history, etc. The mobility vehicle will not be available to other users during this hold period, and the user will receive a notification of the successful reservation. As the hold time approaches, the user can choose to either finalize the rental by completing the payment process or release the mobility vehicle for other users if their plans change. The system can ensure that holds are automatically released if the user does not confirm the rental within the set time, allowing the mobility vehicle to become available for others. This feature enhances the user experience by offering flexibility while providing efficient use of the motorized mobility vehicles.

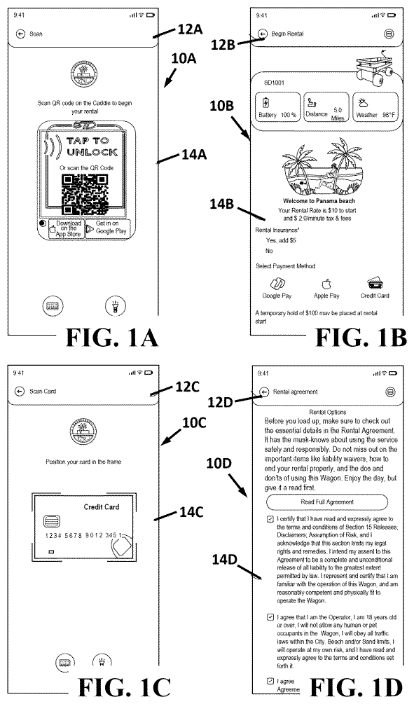

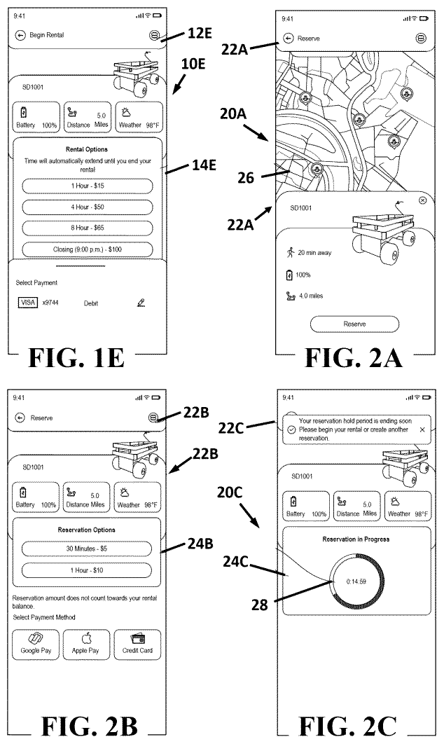

FIGS. 1A-1E and 2A-2C illustrate examples of screens that may be shown as part of, respectively, a rental workflow and a reservation workflow facilitated by an application operating on a user device. Upon arrival at a beach location, a user downloads (if necessary) and logs into the mobile application, which guides a user to select from available motorized mobility vehicles identified by the system based on their GPS coordinates. FIG. 1A shows a rental screen 10A with a header/prompt 12A and a rental window 14A, which instructs the user to scan a QR code on an available mobility vehicle. If the particular mobility vehicle scanned is not currently available (such as being reserved or needing charging or other maintenance), a notice of unavailability can be provided to the user. If the mobility vehicle is available, the workflow proceeds to begin the rental process, showing rental screen 10B with header 12B and rental window 14B, which identifies the mobility vehicle selected, provides information on the rental location, an offer to purchase insurance, and prompts the user to select a payment method. In this case, the user selects to pay by credit card, and is prompted to scan their card in screen 10C, with prompt 12C and scan window 14C. After the card has scanned and any further payment information entered (which may include a prompt to add the card to a memory to facilitate future rentals), the user is then provided with a copy of the rental agreement in screen 10D. upon agreeing to the terms, the user is then prompted in screen 10E to select a time period for the rental. It should be appreciated that the order of screens shown is only one example of the order that could be employed, and the various screens and options could be displayed and user input entered in a different order than that shown.

FIGS. 2A-2C illustrate examples of screens 20A-20C that could be employed in a workflow for reserving a mobility vehicle upon arrival at a destination where mobility vehicles are available at multiple locations. In reservation screen 20A shown in FIG. 2A, a header 22A shows that the application is operating in a reservation rather than rental mode, and a reservation window 24A shows a map 26 identifying the location of available mobility vehicles, along with information on distance and charge status of a particular vehicle once selected. If the user opts to reserve the selected mobility vehicle, reservation options are presented in screen 20B shown in FIG. 2B, with options displayed in reservation window 24B for time periods that the mobility vehicle will be reserved for that user to rent. As with the rental screen 10B shown in FIG. 1B, the user is prompted to select a payment method, and may opt to use a digital payment option or to enter credits card data (which may include scanning a card in the same manner as shown in FIG. 1C). Upon processing the payment information, reservation screen 20C shown in FIG. 2C confirms the reservation in reservation window 24C and provides a timer 28 showing the remaining time to make the rental (using a process such as shown in FIGS. 1A-1E and discussed above) before the mobility vehicle is released and again made available for anyone to rent. As the reservation period nears its end, visual and/or audible warnings may be provided to the user.

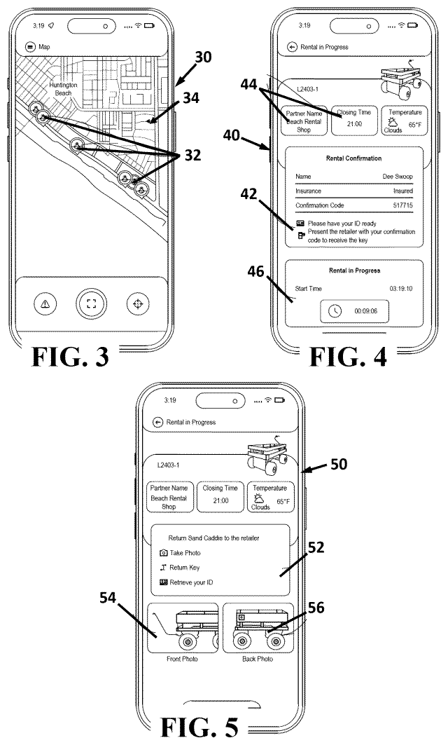

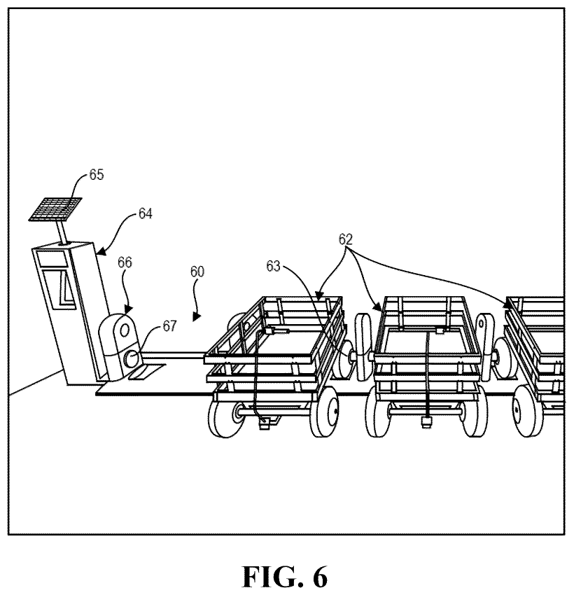

FIG. 3 shows one example of a screenview 30 which could be provided when making a reservation at the destination (such as shown in FIGS. 2A-2C), when making reservations in advance, and/or for providing a user with locations of available mobility vehicles which they can rent upon arrival at the location (such as shown in FIGS. 1A-1E). In the example illustrated, mobility vehicles are available at three different locations 32 near the user (each of which may or may not be a docking station), and the app displays a real-time map 34 showing all available mobility vehicles, allowing user to select a preferred mobility vehicle. Once a mobility vehicle is chosen, user may scan a QR code (as shown in FIG. 1A) or manually input a code to identify the mobility vehicle and start a rental procedure, or may reserve the vehicle before arriving at its location (as shown in FIGS. 2A-2C). As shown in FIGS. 1A-1E and 2A-2C, the user may be prompted to review relevant details, including location, rental terms, and protection options, and after consenting to the rental agreement and completing payment through integrated mobile payment systems (e.g., Apple Pay® or Google Pay®) or by credit card, the mobility vehicle may be activated for access by the user, such as via IoT communication and/or by operating an access control capability at a docking station (such as shown in FIG. 6 and described below).

FIG. 4 shows a screenview 40 illustrating one example of a rental confirmation display, which notifies the user their rental confirmation 42, and may display various data points 44 (providing information about the rental and/or location). A timer 46 may provide information on the rental period and elapsed time, as well as optionally warning the user when the rental period is nearly over. The app may track the rental period, providing real-time updates until the mobility vehicle is returned. FIG. 5 shows one example of a return screenview 50, where the user receives prompts 52 directing them to confirm the location and condition of the mobility vehicle by taking digital photos 54, 56 of the mobility vehicle, and the app ends the rental, and may deactivate the mobility vehicle.

FIG. 6 illustrates one example of a docking station 60 for motorized mobility vehicles 62, serving as both a storage and charging hub for the mobility vehicles 62. The mobility vehicles 62 have wheel hubs 63 which may serve for charging interfaces, securing interfaces, or both. The docking station 60 illustrated has a station base 64 that houses equipment to perform communications (with a control hub not shown and, in some cases, with the mobility vehicles 62), charging for the mobility vehicles 62, optional camera monitoring of the surrounding area, and any other necessary functions. The station base 64 may include a solar panel 66 to provide at least a portion of its power. As shown in FIG. 6, the docking station 60 can be strategically placed in a high-traffic area along the sand, or other convenient location such as a parking lots or boardwalk, to make the mobility vehicles 62 easily accessible to users upon arrival (examples of multiple locations are shown in FIG. 3). The locations of the docking stations 60 can be selected to optimize convenience, allowing beachgoers to pick up or return their rented mobility vehicles with minimal hassle. Docking stations placed in parking lots, for instance, allow users to retrieve or return their mobility vehicles as they transition from their vehicles to the beach, while stations along the sand or boardwalks can serve as centralized hubs for beachgoers walking to and from their destinations.

Each docking station may be equipped with a secure housing unit or other structure to secure the motorized mobility vehicles when they are not in use. Such structure could include full enclosures (such as one or more sheds), partial enclosures (such as one or more fenced-in areas), and/or open structures to which mobility vehicles may be secured (such as one or more locking racks). In some cases, access could be controlled by controlling access to a key or other access device that is needed to access a particular mobility device. In the docking station 60 shown, such securing is provided by a rack 66 that has paired hub-engaging elements 67 that can be extended to secure the wheel hubs 63 of a mobility vehicle 62 parked between the hub-engaging elements 67. The docking stations may feature security features to prevent theft or damage to the mobility vehicles, such as locking mechanisms and video surveillance capabilities to keep the mobility vehicles safe and operational. Additionally, the stations may have charging capabilities, allowing the motorized mobility vehicles to remain fully charged and ready for use. When the wheel hubs 63 are appropriately equipped, charging could be performed via the hub-engaging elements 67. The charging system may be designed to be energy-efficient and sustainable, incorporating solar panels (such as solar panel 66 shown in FIG. 6) or other renewable energy sources where possible. This approach reduces the environmental impact of the system while providing a reliable source of power for the mobility vehicles. The docking stations will also be equipped with real-time monitoring systems that track the status of each mobility vehicle, including battery levels and condition, allowing administrators to manage fleet health to help maintain the mobility vehicles in an operational condition. Docking stations may also securely store and control access to mobility mats that can be rented along with the mobility vehicles 62 to facilitate travel over soft sand or similar surfaces.

The docking stations can also serve as a point for the administration and maintenance of the mobility vehicles. As part of the administrative interface, the docking station may collect and aggregate reservation data and provide such aggregated data along with any relevant real-time data to business owners or operators. Such data may include usage statistics, location information, and alerts for maintenance needs. For example, if a mobility vehicle requires charging, a notification can be sent to administrators to prompt the repositioning of the mobility vehicle to a charging station. Additionally, docking stations may be equipped with IoT technology that enables communication between the mobility vehicle and the mobile application operating on a user device.

When a user returns a mobility vehicle, the docking station may participate in confirming the return through an automatic check-in process, where the docking station interacts with the mobile application to updates the rental status in the application and provide the user with a receipt for their rental period (alternatively, some of these functions may be provided by a control unit on the mobility vehicle being returned).

In terms of physical design, the docking stations should be built to withstand the elements and the demands of high-traffic public areas, such as being made from durable, weather-resistant materials. The docking stations may be equipped with easy-to-read user interfaces, making it simple for customers to engage with the system, whether they are renting, returning, or checking on the status of the motorized mobility vehicles. Such interface may be designed to allow users to rent mobility vehicles without using a mobile device. With modular designs, the stations can be expanded or adjusted depending on the volume of mobility vehicles and the needs of different locations.

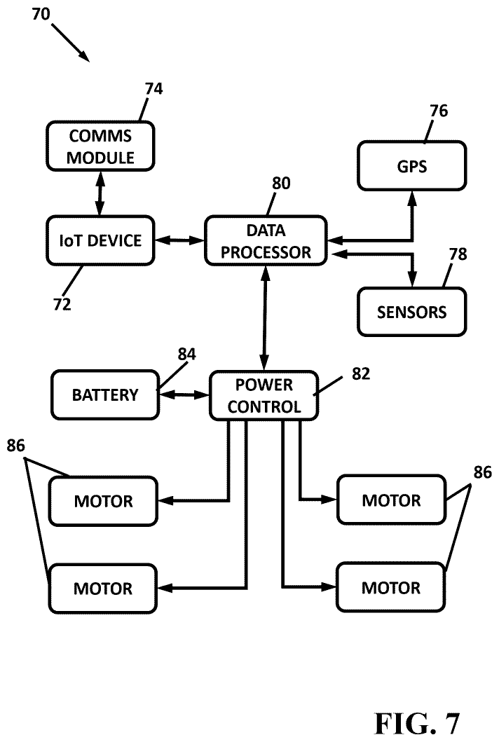

FIG. 7 is a block diagram illustrating one example of a control unit 70 for a motorized mobility vehicle. The control unit 70 has an Internet of Things (IoT) device 72 that communicates with external system elements (such as a control hub, docking stations, and/or a mobile application running on user devices) via a communications module 74, which may be integrated with the IoT device 72. A GPS module 76 is provided to track the current location of the mobility vehicle, and other sensors 78 can be provided to monitor conditions of the mobility vehicle and its components (for example, battery charge status, other operational status indicators, etc.) Data from the IoT device 72, the GPS module 76, and the sensors 78 are provided to a data collection/processing module 80, which operates in cooperation with the IoT device 72 to operate the mobility vehicle. The data collection/processing module 80 directs a power control module 82, which controls the supply of electrical power from a battery 84 (which may be a single battery or a bank of multiple batteries) to a number of motors 86 that control the motion of the MOBILITY VEHICLE (alternatively, a single motor controlling motion of the wheels via a transmission could be employed). While reference is made to GPS for tracking the location, any suitable location technique (such as location derived from signals nearby cell towers) can be employed by the GPS module 76.

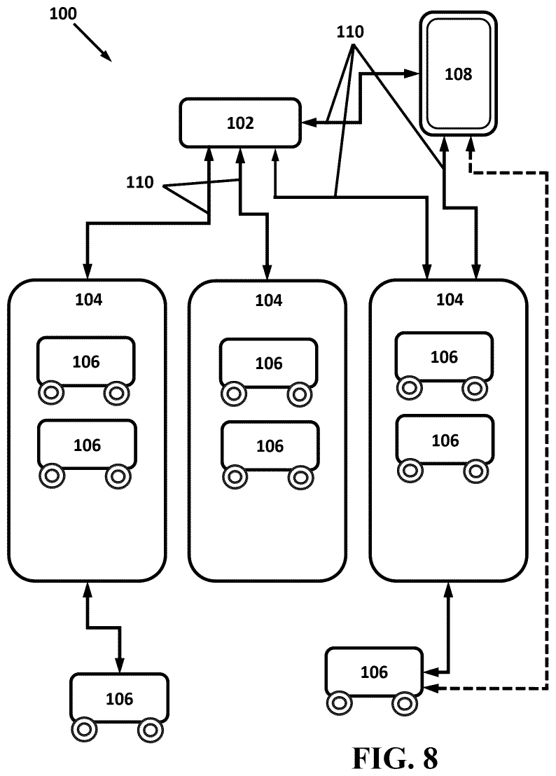

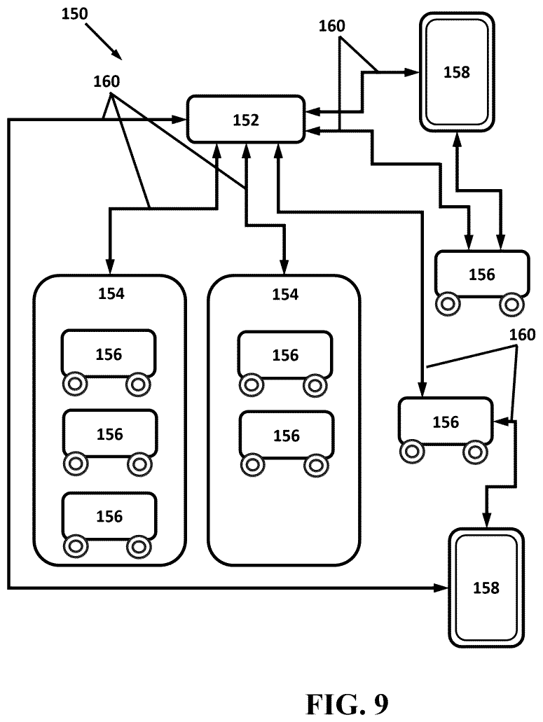

The communications module 74 may communicate with other system elements via Wi-Fi or Bluetooth connectivity, with the IoT device 72 acting to establish a secure, two-way connection between the mobility vehicle and the other system element(s) (three options of control schemes are shown in FIGS. 8-10). As one example, whenever a user interacts with the app to reserve or rent a mobility vehicle, the mobile application could send a request to a central server. Upon approval of this request, a command can then be relayed to the IoT device 72 of the respective mobility vehicle (either directly from a communications capability of the central server, via a docking station at which the mobility vehicle is located, or via a user device operating an application communicating with the central server. The IoT device 72 can process the command (or send it to the data collection/processing module 80 for at least partial processing) and the data collection/processing module 80 directs the power control module 82 to activate the mobility vehicle accordingly. Communication protocols such as MQTT (Message Queuing Telemetry Transport), HTTP (Hypertext Transfer Protocol), or SMS (Short Message Service) might be used to provide real-time and efficient data transfer, providing instant feedback to the mobile app, such as confirming the mobility vehicle's activation or rental status.

The IoT device 72 within the mobility vehicle may manage these interactions by providing an additional layer of connectivity and control. It may work as a bridge between the PCB and the external world, transmitting commands received from the mobile app (or other system element) to the mobility vehicle's internal systems. For example, when a command to activate a mobility vehicle is received, the IoT device 72 communicates with the data collection/processing module 80 to activate the power control module 82, enabling the mobility vehicle to function. The IoT device 72 also allows the mobility vehicle to send operational data collected (and in some cases processed) by the data collection/processing module 80 back to the mobile app (or other system element), such as the mobility vehicle battery status, location updates via GPS, and any diagnostic information (e.g., if maintenance is needed). This constant flow of data between the IoT device 72, data collection/processing module 80, and mobile app can help the mobility vehicle to respond to user commands and provides transparency on its operational status.

In terms of security, the control unit 70 and its circuitry may be designed to prevent unauthorized access, ensuring that only verified users can interact with the motorized mobility vehicle. Encryption methods may be employed to protect data transmitted between the data collection/processing module 80, IoT device 72, and mobile application, guarding against potential security breaches. Additionally, the mobility vehicle's control unit may be designed with fail-safe mechanisms to prevent operational errors. For instance, if communication between the IoT device 72 and the server is lost, the control unit 70 may default to a safe mode, where the power control module 82 disables power to the motors 86, so that the motorized mobility vehicle automatically disables itself, ensuring it cannot be rented or used until the issue is resolved. As another example, the use of the mobility vehicle may be limited to a geographical region where it is rented, and the data collection/processing module 80 may deactivate it if removed from that region, as indicated by the GPS module 76.

The IoT device 72 and/or the data collection/processing module 80 may also have an adaptive component that allows the control scheme of the mobility vehicle to evolve based on future needs. For instance, software updates can be sent remotely to the data collection/processing module 80 to adjust performance parameters or introduce new features, such as enhanced battery management or additional sensor integration. This adaptability can allow the motorized mobility vehicles to remain state-of-the-art, capable of supporting future upgrades and evolving user requirements.

Alternatives to the particular arrangement shown in FIG. 7 may be employed to provide the functional capabilities described for the various components, such as using integrated devices to provide some or all functions shown as provided by separate elements. As examples, the functions of the data collection/processing module 80 the power control module 82 might be integrated into a single “controller”, or the functions of the power control module 82 might be provided by separate power controllers associated with each of the motors 86.

FIG. 8 illustrates one example of a system 100 for providing mobility vehicle access. The system 100 has a control hub 102 that communicates with a plurality of docking stations 104, each of which serves to store and control access to a number of mobility vehicles 106, each suitable for transporting objects (such as beach wagons) or people (such as beach-adapted wheelchairs). The docking stations 104 may be located for public or private availability at a number of convenient locations. In the system 100, the mobility vehicles 106 communicate with the control hub 102 via one of the docking stations 104.

The control hub 102 receives information from the docking stations 104 about the mobility vehicles 106 available at each docking station 104 to determine availability, and communicates with a user device 108 (such as a computer or smart phone) to present availability data to a user of the device 108 and allowing the user to input reservation requests for an available mobility vehicle 106 at a particular one of the docking stations 104. Communications between the system components 102, 104, and 106 and with the user device 108 can be made using a wireless communications network 110. The docking stations 104 may have a user interface to allow a user to access an available mobility vehicle 106 without using a user device 108, either instead of or in addition to processing reservations via a user device 108. The control hub 102 receives a reservation request inputted by the user and processes a payment for the reservation. Either the control hub 102 or the docking station 104 matches the reservation information to an available one of the mobility vehicles 106 at that docking station 104, and updates the vehicle availability data to account for the reserved mobility vehicle 106 being unavailable during the reservation time.

The docking stations 104 may communicate with the control hub 102 for controlling and monitoring activity of the mobility vehicles 106 for purposes beyond simply enabling and disabling access. When the mobility vehicles 106 are powered, communication can inform the docking station 104 of the current charge status of each mobility vehicle 106 when it is returned, so that batteries of the mobility vehicle 106 can be recharged before it is accessed again. Similarly, other diagnostic information relating to maintenance and operable status can be communicated to the docking station 104. The docking stations 104 may provide information for logistic or for signal strength and GPS considerations, and may provide statistical information to the control hub 102.

Communication between the control hub 102 and the mobile device 108 may be partially or entirely provided via a mobile application operating, at least partially, on the user mobile device 108 to facilitate reservation and rental workflows for rental of a particular mobility vehicle 106. The mobile application may present users with real time maps (displayed on the mobile device 108) showing which docking stations 104 have available mobility vehicles 106 and provide confirmation and data points for the rental of the mobility vehicles 106. The mobile application may confirm the ending of the rental process with photo confirmation of the mobility vehicle 106 location and/or condition. Mobility vehicles 106 may include wheeled vehicles which may be motorized or towed by a user, and provide transportation of user belongings or other objects, as well as vehicles such as wheelchairs that are adapted for use on sift and/or uneven terrain.

Tracking of the location of mobility vehicles 106 may be provided by a GPS device (such as GPS module 76 shown in FIG. 7). The GPS device (as well as any other elements of the control unit for the mobility vehicle 106) may be integrated into the body of the mobility vehicle, forming a single, unified object to deter tampering. This integration may be achieved through various methods, such as embedding the GPS device within the mobility vehicle during the manufacturing process, or attaching the GPS device to the mobility vehicles post-manufacturing. In other cases, the GPS device may be a separate unit that can be attached to the mobility vehicle through various means, such as adhesive, clips, or straps. The GPS device may be designed to be small and lightweight, minimizing any impact on the usability of the mobility vehicles. The GPS device may be equipped with a power source, such as a battery, to enable its operation. In some cases, the power source may be rechargeable, allowing for extended use of the GPS device. The GPS device may also include a dedicated communication module to transmit current location data to a user and/or to one or more system elements (such as a control hub and/or a docking station). This communication module may utilize various communication protocols, such as Bluetooth, Wi-Fi, or cellular networks (any of which, alone or in combination, may provide the wireless communications network 110), to transmit the data to the user mobile device 108 and/or the docking stations 104. The GPS device may include a dedicated memory module for storing location data. This memory module may allow for the storage of historical location data, providing a record of the mobility vehicle's movements over time. The stored data may be accessed by the user at any time, providing valuable information about the mobility vehicles's usage patterns and locations. While discussed as dedicated functions of the GPS device, such functions could be wholly or partially provided by separate elements of a control unit for the mobility vehicle (such as by data collection/processing module 80 shown in FIG. 7).

Either the control hub 102 or the docking station 104 receiver user identification information and matches the users to the reservation they have placed. Responsive to matching the user with a valid reservation, the docking station allows the user to access an appropriate mobility vehicle 106, and matches a unique identifier for the accessed vehicle to a record for the reservation. In some cases, allowing access may enable the user device 108 to interact directly with the mobility vehicle 106, rather than communicating via one of the docking stations 104.

FIG. 9 illustrates one example of a system 150 that has many features in common with the system 100, but where a control hub 152 communicates directly with both a plurality of docking stations 154 and a plurality of mobility vehicles 156. In the system 150, the control hub 152 may obtain vehicle availability data directly from the mobility vehicles 156 and/or from the docking stations 154. The control hub 152 communicates with a user device 158 to allow a user of the device 158 to reserve and access a particular mobility vehicle 156, and the accessed mobility vehicle 156 may be in direct communication with the user device 158 while access is enabled. Communications can be provided via a wireless communications network 160, which again may employ various communication protocols, such as Bluetooth, Wi-Fi, and/or cellular networks.

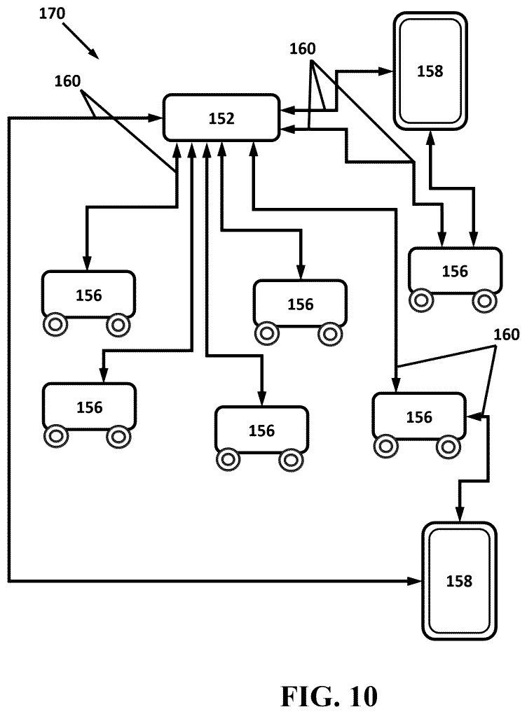

FIG. 10 illustrates one example of a system 170 that has many features in common with the system 150, where a control hub 152 again communicates directly with a plurality of mobility vehicles 156 to control access to them. In the system 170, the control hub 152 obtains vehicle availability data directly from the mobility vehicles 156 and communicates with a user device 158 to allow a user of the device 158 to reserve and access a particular mobility vehicle 156, and the accessed mobility vehicle 156 may be in direct communication with the user device 158 while access is enabled. Docking stations (not shown) could be employed for uses such as recharging batteries, but in the system 170 are not employed in controlling access to the mobility vehicles 156.

While the systems illustrated above show functional elements as separate, some functions could be integrated, such as by incorporating some functions described as being performed by the control hub being provided by processing capability located at the docking stations and/or the mobility vehicles. In such cases, some communications handled at the same location could be via wire communications.

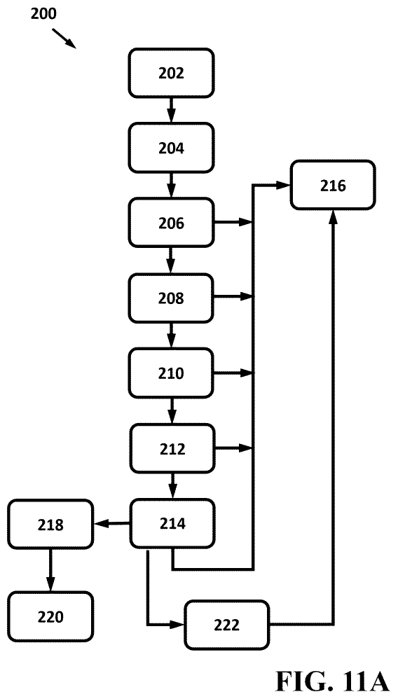

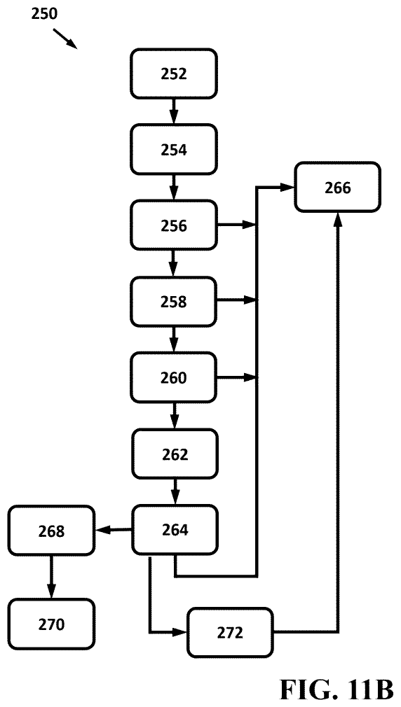

FIG. 11A illustrates one example of a method 200 for of controlling access to a plurality of mobility vehicles, each having a unique identifier. The method 200 begins by accessing vehicle availability data and presenting a user with information on available mobility vehicles (step 202), which allows the user to define a reservation (step 204) for an available mobility vehicle. In step 206, payment information for the reservation is processed, and a record of the reservation is made in step 208. The availability data is also adjusted in step 208 to account for unavailability of the reserved mobility vehicle during the reservation time. In step 210, user identification information is received to match the user with the reservation, and the reservation is matched to a particular mobility vehicle in step 212 (note that either or both of these matching steps (210, 212) could be performed earlier on the process). The user is allowed temporary access to the matched mobility vehicle in step 214, responsive to matching the received user identification information with a valid reservation.

Optionally, information received in steps 206-212 cam be collected, aggregated, and reported (along with any relevant information collected during the rental period) in step 216. Such aggregated information may be reported to a management information database. While not illustrated, real-time data on the current condition of the mobility vehicle may also be reported. At the end of the rental period, the method may prompt users to input image information (step 218), and may store such inputted image information as part of a record of the reservation in step 220. Such image information may include digital photographs of the mobility vehicle with a location tag to confirm the return of the mobility vehicle to the appropriate location and in good condition. The current location of the mobility vehicle may be tracked via GPS (this term including both location determination by GPS signals and any analogous techniques, such as deriving location from nearby cell phone signal transmitters) at least while the mobility vehicle is in use (step 222), and such information can be collected, aggregated, and reported as part of step 216.

FIG. 11B illustrates a method 250 which has many similarities to the method 200, but in this example a reservation for a mobility vehicle is placed in advance of the time it is intended to be used. Again, vehicle availability data is accessed and presented to user (step 252), and in this case includes times and dates when mobility vehicles are available at each location. The user is allowed to define a reservation (step 254), where the definition includes a date and time (as well as location). Payment information is processed (step 256) and a record made of the reservation and the vehicle availability data adjusted accordingly (step 258). At the date and time of the reservation, user identification information is received at the location to match the user with the reservation (step 260). If there is a match to a valid reservation or that date and time, the user is allowed temporary access to one of the mobility vehicles (step 264). A unique identifier for a particular mobility vehicle accessed is matched to the reservation (step 266); this step could be performed earlier (such as matching a particular mobility vehicle to the reservation at the time the reservation is made) or may be performed at the time the mobility vehicle is accessed (such as by allowing the user to select an available mobility vehicle and then recording the identifier for the selected mobility vehicle). Again, information obtained in various steps may be collected, aggregated, and reported (step 266), and real-time data may also be reported. At the end of the rental, the user may again be prompted (step 268) to input image information and such information stored as a part of the reservation record (step 270). The location of the mobility vehicle may be tracked via GPS or similar signal monitoring location technique (step 272).

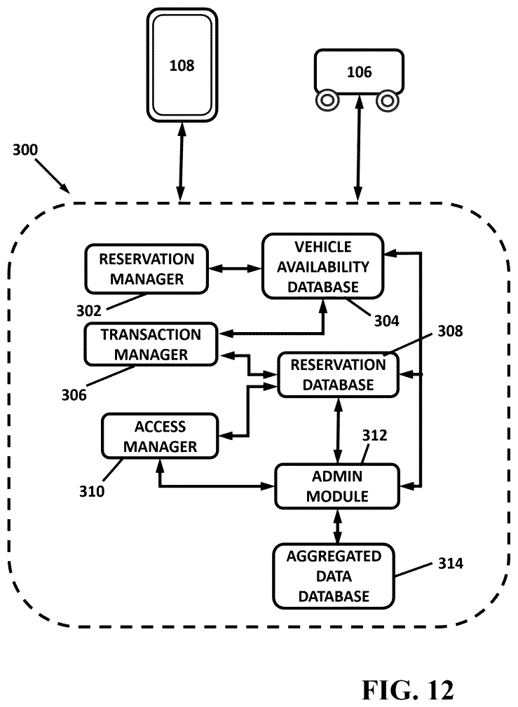

FIG. 12 illustrated one example of a software application 300 for managing access to at least one mobility vehicle 106, the software application operating in cooperation with a user mobile device 108. The software may operate primarily on the user device 108, primarily on a server (not shown), or some combination of these approaches. While particular functional components are described for purposes of discussion, the software elements that perform particular functions may be grouped differently than illustrated. The application 300 includes a reservation manager 302 that accesses vehicle availability data from a vehicle availability database 304, and present a user of the device 108 with information on available mobility vehicles. The reservation manager 302 allows the user to select a reservation for at least one available mobility vehicle. A transaction manager 306 receives payment information input by the user on the device 108. When a valid payment is processed, the transaction manager 306 records the reservation information in a reservation database 308, and adjusts the vehicle availability database 304 to account for the reserved vehicle being unavailable during the reservation time. At the time of the reservation, an access manager 310 receives user identification information inputted via the user device 108, and matches the identified user with a reservation recorded for that user in the reservation database 308. If there is a valid reservation record that matches, the access manager allows the user temporary access to the mobility vehicle 106 such as by directing the mobility vehicle 106 directly to activate, or by directing a docking station (not shown) to allow access to the mobility vehicle 106. An administration module 312 may collect data on reservations from the access manager 3410, the vehicle availability database 304, the reservation database 308, and other components of the application 300, and may aggregate such data for storage in an aggregated data database 314 for use in management, business optimization, and similar analysis purposes.

Where the mobility vehicles 106 are stored in different locations, the vehicle availability database 304 includes information on the availability of mobility vehicles at different locations, and the reservation manager 302 may presents the user with a map of locations where mobility vehicles are available displayed on the user device 108. In such cases, the transaction manager 310 matches reservations to a location selected by the user. Similarly, where the application 300 allows users to reserve mobility vehicles in advance, the vehicle availability database 304 and the reservation database 308 include dates and times when mobility vehicles are reserved. In cases where the mobility vehicles 106 are powered by electric motors, the access manager 310 may control access by sending commands to enable and disable the electric motors. The access manager 310 may send prompts for the user to input image information (such as by taking photographs of the mobility vehicle 106 using the user device 108) to terminate the reservation, and the transaction manager 306 (or other component of the application 300) may store such image information as part of a record of the reservation in the reservation database 308.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for providing mobility vehicle access, the system comprising:
a control hub;
a plurality of mobility vehicles each having a unique identifier; and
at least one docking station that can store at least a portion of the plurality of mobility vehicles when not in use,
said control hub being in signal communication with at least one of said mobility vehicles and said docking station(s), and
said control hub acting to,
access vehicle availability data to present to users and allowing users to input reservation requests for available mobility vehicles,
receive reservation requests and process payments for reservations,
match reservation information to an available one of said mobility vehicles, and update the vehicle availability data to account for unavailability of the reserved mobility vehicle during the reservation time,
receiving user identification information at the docking station(s) where reserved mobility vehicles are stored and matching users to reservations,
responsive to matching each user with a reservation, allowing such user to temporarily access a reserved mobility vehicle, and
matching the identifier for the accessed mobility vehicle to the reservation.

2. The system of claim 1 wherein the at least one docking station comprises a plurality of docking stations at different locations, and
wherein the vehicle availability data includes the location(s) at which mobility vehicles are available, and said control hub presents the vehicle availability data to users in a format including a map identifying locations of available mobility vehicles, and allowing users to input reservation requests for available mobility vehicles where the reservation request specifies a mobility vehicle location.

3. The system of claim 1 wherein at least some of said mobility vehicles are powered by electric motors and said docking stations include the capability to recharge batteries in said mobility vehicles to power said electric motors.

4. The system of claim 1 wherein said control hub acts to prompt users to input image information to terminate the reservation and stores such image information as part of a record of the reservation.

5. The system of claim 1 wherein said control hub interacts with user devices via a wireless communications network.

6. The system of claim 5 wherein said control hub allows users to schedule reservations in advance.

7. The system of claim 1 wherein said control hub is in signal communication with said at least one docking station and said mobility vehicles communicate with said control hub, at least in part, via said at least one docking station.

8. A method of controlling access to a plurality of mobility vehicles, each having a unique identifier, the method comprising the steps of:
accessing vehicle availability data and presenting a user with information on available mobility vehicles;
allowing a user to define a reservation for an available mobility vehicle;
processing payment information;
making a record of the reservation and adjusting the vehicle availability data to account for unavailability of the reserved mobility vehicle during the reservation time;
matching the identifier for a particular mobility vehicle to the reservation;
at the location of the particular mobility vehicle(s) identified, receiving user identification information to match the user with the reservation;
responsive to matching the received user identification information with the reservation record, allowing the user temporary access to one of the mobility vehicles suitable to match the reservation.

9. The method of claim 8 wherein the mobility vehicles are stored at different locations, wherein:
the vehicle availability data includes the location(s) at which mobility vehicles are available, and said step of presenting a user with information on available mobility vehicles includes presenting the user with a map identifying locations of available mobility vehicles;
said step of allowing a user to define a reservation defines a location of the reserved mobility vehicle; and
said step of making a record of the reservation and adjusting the vehicle availability data takes into account the location of the reserved mobility vehicle.

10. The method of claim 8 further comprising the step of:
collecting and aggregating reservation data and reporting such aggregated reservation data to a management information database.

11. The method of claim 8 further comprising the steps of:
prompting users to input image information to terminate the reservation; and
storing inputted image information as part of a record of the reservation.

12. The method of claim 8 wherein said steps of presenting a user with information on available mobility vehicles, allowing a user to define a reservation for an available mobility vehicle, processing payment information, and receiving user identification information are at least partially performed via a user device.

13. The method of claim 12 wherein said steps of presenting a user with information on available mobility vehicles and allowing a user to define a reservation allows users to schedule reservations in advance.

14. The method of claim 8 further comprising the step of:
tracking the current location of at least a subset of the mobility vehicles via GPS location capability.

15. A software application for managing access to at least one mobility vehicle, the software application comprising:
a reservation manager that accesses vehicle availability data to present a user with information on available mobility vehicles and allows the user to select a reservation for at least one available mobility vehicle;
a transaction manager that receives payment information input by the user and, upon confirming the validity of the payment information,
processes a payment identified by the payment information,
records the reservation in a reservation database, and
adjusts the vehicle availability data to account for unavailability of the reserved mobility vehicle during the reservation time;
an access manager that receives user identification information to match the user with a reservation recorded for that user and, responsive to matching the received user identification information with the reservation record, allows the user temporary access to a mobility vehicle suitable to match the reservation, said access manager matching the reservation with the identifier for the mobility vehicle made accessible to the user.

16. The software application of claim 15 wherein the vehicle availability data includes information on the availability of mobility vehicles at different locations and presents a user with a map of locations where mobility vehicles are available and matches reservations to a location selected by the user.

17. The software application of claim 15 wherein at least some of said mobility vehicles are powered by electric motors and said access manager sends commands to enable and disable the electric motors to control access.

18. The software application of claim 15 wherein said access manager prompts users to input image information to terminate the reservation and said transaction manager stores such image information as part of a record of the reservation.

19. The software application of claim 15 wherein said reservation manager allows users to schedule reservations in advance.

20. The software application of claim 15 further comprising:
an administration module that collects each reservation record and aggregates reservation data for multiple reservations.
